(19) United States
(12) Patent Application Publication
(10) Pub. No.: US 2010/0024960 A1
(43) Pub. Date: Feb. 4, 2010

(54) BODY PLY AND INSERT ASSEMBLY METHOD

(75) Inventors: Jie Jin, Copley, OH (US); Michael Crano, Fairlawn, OH (US)

Correspondence Address: BRIDGESTONE AMERICAS, INC., 1200 FIRESTONE PARKWAY, AKRON, OH, 44317, US

(73) Assignee: BRIDGESTONE AMERICAS TIRE OPERATIONS, LLC, Nashville, TN (US)

(21) Appl. No.: 12/577,235

(22) Filed: Oct. 12, 2009

Related U.S. Application Data
(63) Continuation-in-part of application No. 11/219,160, filed on Sep. 1, 2005, now Pat. No. 7,624,779.

(51) Int. Cl. B29D 30/32; B29D 30/16

(52) U.S. Cl. 156/132; 156/133

(57) ABSTRACT

A tire having a tread including first and second reinforcement plies disposed between at least one carcass ply and the tread and at least one of the sidewalls of the tire. A method for making a tire body ply is also described. The method includes delivering a first rubber coating, at least one insert, a body fabric, and a second rubber coating to a bite formed by at least two calendering rollers. The method further includes pressing the first rubber coating, the body fabric, the at least one insert, and the second rubber coating through the bite and then between the at least two calendering rollers to form a tire body ply. In another embodiment, the method includes spacing a first insert from a center of the tire body ply by a first distance and a second insert from the center of the tire body ply by a second distance.

### CROSS-REFERENCE TO RELATED APPLICATIONS

This U.S. non-provisional application is a continuation-in-part application that claims priority from U.S. Non-provisional patent application Ser. No. 11/219,160, inventors Jin et al., entitled TIRE HAVING A SIDEWALL REINFORCEMENT, filed Sep. 1, 2005, the disclosure of which is incorporated by reference herein in its entirety.

### FIELD OF THE INVENTION

The present application relates to tires and, more particularly, to a tire with a sidewall reinforcement to improve sidewall performance of the tire and a body ply and insert assembly method.

### BACKGROUND

In an inflated and loaded condition, a radial tire is subject to bending moments at the sidewall areas at the center of the tire footprint. The strains and stresses created by the moments are directly related to the sidewall performance of the tire.

Previous research and studies have demonstrated that the maximum sidewall surface strain occurs in the least stiff area of the sidewall of a tire. Because of cord compression created during the loading of the tire, the combined cord tension in the upper sidewall area is reduced and that area is most vulnerable to sidewall bending. Therefore, the maximum sidewall surface strain is located in the upper sidewall area.

### SUMMARY

A tire, which has a maximum section width, an upper section above the maximum section width, and a lower section below the maximum section width, includes a tread extending circumferentially about the tire, a pair of sidewalls, a pair of bead assemblies, and at least one carcass ply extending circumferentially about the tire from one bead assembly to the other. The tire further includes first and second reinforcement plies extending circumferentially about the tire, disposed between the at least one carcass ply and the tread and at least one of the sidewalls of the tire. The first and second reinforcement plies have lower ends that terminate in the lower section of the tire.

Further, a method for making a tire body ply is also described. The method includes delivering a first rubber coating to a bite formed by at least two calendering rollers, delivering at least one insert to the bite, delivering a body fabric to the bite, and delivering a second rubber coating to the bite. The method further includes pressing the first rubber coating, the body fabric, the at least one insert, and the second rubber coating through the bite and then between the at least two calendering rollers to form a tire body ply having a total width, a thickness, and a length. In one embodiment, the method also includes placing the body fabric and the at least one insert between the first rubber coating and the second rubber coating and placing the at least one insert between the first rubber coating and the body fabric. In another embodiment, the method includes placing a first insert having a first width so it is spaced from a center of the tire body ply by a first distance and placing a second insert having a second width so it is spaced from the center of the tire body ply by a second distance.

### BRIEF DESCRIPTION OF DRAWINGS

In the accompanying drawings, embodiments of a body ply and insert assembly method are illustrated that, together with the detailed description provided below, describe exemplary embodiments of body ply and insert assembly methods. One of ordinary skill in the art will appreciate that a step may be designed as multiple steps or that multiple steps may be designed as a single step.

Further, in the accompanying drawings and description that follow, like parts are indicated throughout the drawings and written description with the same reference numerals, respectively. The figures are not drawn to scale and the proportions of certain parts have been exaggerated for convenience of illustration.

FIG. 1 is a cross-sectional view of one embodiment of half of a tire 100.

FIG. 2 is an enlarged perspective view of a portion of the tire 100 of FIG. 1.

FIG. 3 is a perspective view of one embodiment of a portion of a dual reinforcement layer provided in the tire 100 of FIG. 1.

FIG. 4 is a plot illustrating sidewall surface strain of a P255/45R18 tire with and without a sidewall dual layer reinforcement.

FIG. 5 is a side view of a body ply and insert assembly process.

FIG. 6 is a top view of the body ply and insert assembly process illustrated in FIG. 5.

FIG. 7 is a cross sectional view of the body ply and insert assembly illustrated in FIG. 6 along line A-A.

FIG. 8 is a front view of the body ply and insert assembly including bead portions.

FIG. 9 is a front view of the body ply and insert assembly with bead portions in a folded position.

FIG. 10 is flow diagram of the body ply and insert assembly method.

### DETAILED DESCRIPTION

The following includes definitions of selected terms employed herein. The definitions include various examples and/or forms of components that fall within the scope of a term and that may be used for implementation. The examples are not intended to be limiting. Both singular and plural forms of terms may be within the definitions.

“Axial” or “axially” refer to a direction that is parallel to the axis of rotation of a tire.

“Bite” or “calender bite” refer to a location between two rollers where materials merge, wherein the two calender rollers press the materials together.

“Circumferential” and “circumferentially” refer to lines or directions extending along the perimeter of the surface of the tread parallel to the equatorial plane and perpendicular to the axial direction of the tire.

“Equatorial plane” refers to the plane that is perpendicular to the tire's axis of rotation and passes through the center of the tire's tread.

“Groove” refers to an elongated void area in the tread of the tire that extends circumferentially in a straight, curved or zig-zag manner.

“Lateral” or “laterally” refer to a direction along the tread of the tire going from one sidewall of the tire to the other sidewall.

“Radial” or “radially” refer to a direction perpendicular to the axis of rotation of the tire.

“Sidewall” refers to that portion of the tire between the tread and the bead.

“Tread” refers to that portion of the tire that comes into contact with the road under normal load.

Directions are also stated in this application with reference to the axis of rotation of the tire. The terms “upward” and “upwardly” refer to a general direction towards the tread of the tire, whereas “downward” and “downwardly” refer to the general direction towards the axis of rotation of the tire. Thus, when relative directional terms such as “upper” and “lower” are used in connection with an element, the “upper” element is spaced closer to the tread than the “lower” element. Additionally, when relative directional terms such as “above” or “below” are used in connection with an element, an element that is “above” another element is closer to the tread than the other element. The terms “inward” and “inwardly” refer to a general direction towards the equatorial plane of the tire, whereas “outward” and “outwardly” refer to a general direction away from the equatorial plane of the tire and towards the sidewall of the tire. Thus, when relative directional terms such as “inner” and “outer” are used in connection with an element, the “inner” element is spaced closer to the equatorial plane of the tire than the “outer” element.

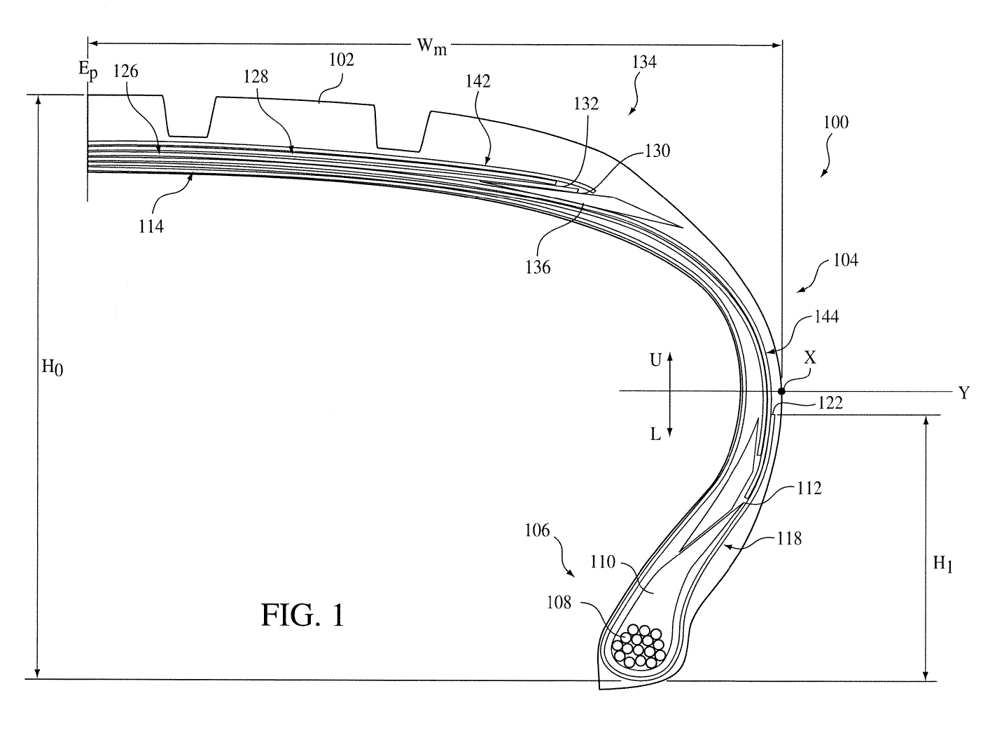

Illustrated in FIG. 1 is a cross-sectional view of half of one embodiment of a tire 100. Although only half of the tire 100 is depicted in the drawings, it will be appreciated that the other half of the tire 100 is a substantial mirror image of the half depicted. The tire 100 has an equatorial plane Eₚ and a maximum section width Wₘ measured from the equatorial plane Eₚ to the outer most point of the tire 100 (i.e., point X). The tire 100 can be divided into two sections—an upper section U and a lower section L. Separating the upper section U from the lower section L is a hypothetical line Y drawn through point X that is substantially parallel to the axis of rotation of the tire 100. The upper section U is the portion of the tire 100 that is disposed above the maximum section width Wₘ of the tire 100 (represented by line Y), while the lower section L is disposed below the maximum section width Wₘ of the tire 100 (represented by line Y).

With continued reference to FIG. 1, the tire 100 includes a tread 102 provided in the upper section U of the tire 100, a sidewall 104 provided in both the upper and lower sections U, L of the tire 100, and a bead assembly 106 provided in the lower section L of the tire 100. The bead assembly 106 includes a bead core 108 and a bead filler 110 having an upper end 112.

A carcass ply 114 extends circumferentially about the tire 100 from one bead assembly (e.g., bead assembly 106) to the other bead assembly (not shown). The carcass ply 114 is wound outwardly about the bead core 108 and extends upwardly towards the tread 102 to form a turn-up portion 118. The turn-up portion 118 terminates at a turn-up end 122. Although the tire 100 illustrated in FIG. 1 includes one carcass ply, the tire 100 can include two or more carcass plies in alternative embodiments (not shown).

With continued reference to the embodiment illustrated in FIG. 1, the turn-up portion 118 of the carcass ply 114 has a height H₁ measured radially from the turn-up end 122 to the base of the bead core 108. Preferably, the height H₁ of the first turn-up portion 118 is between about 30% and about 70% of the section height H₀ (which is measured from the outer tread surface at the equatorial plane Eₚ to the base of the bead core 108). In alternative embodiments (not shown), the height H₁ of the first turn-up portion 118 may be less than 30% or greater than 70% of the section height H₀ depending on the design.

In one embodiment, the carcass ply 114 includes parallel-aligned cords that are radially disposed. In other words, the parallel-aligned cords are oriented substantially perpendicular to the equatorial plane Eₚ of the tire 100. In alternative embodiments, the carcass ply can include parallel-aligned cords that are biased with respect to the equatorial plane Eₚ of the tire 100. In all cases, the cords can be constructed of, for example, nylon or polyester.

With continued reference to FIG. 1, the tire 100 further includes first and second belts 126, 128 that extend circumferentially about the tire 100. The first and second belts 126, 128 are provided between the tread 102 and the first and second carcass plies 114, 116 as shown in FIG. 1. The first and second belts 126, 128 terminate at edges 130, 132, respectively, at a location near a shoulder region 134 of the tire 100. Although the tire 100 illustrated in FIG. 1 features two belts, the tire 100 can include a single belt or more than two belts in alternative embodiments (not shown).

In one embodiment, the first and second belts 126, 128 include parallel-aligned cords or wires that are radially disposed. In alternative embodiments, one or more of the belts can include parallel-aligned cords or wires that are biased with respect to the equatorial plane Eₚ of the tire 100. In all cases, the cords or wires can be constructed of, for example, steel or other steel alloys.

With continued reference to FIG. 1, the tire 100 also includes a belt edge insert 136 provided in the shoulder region 134 of the tire 100 between the edges 130, 132 of the first and second belts 126, 128, respectively, and the carcass ply 114 as shown in FIG. 1. The belt edge insert 136 has an inner end 138 and an outer end 140. The belt edge insert 136 is configured to protect the carcass ply 114 from the edges of the belts 126, 128. The belt edge insert 136 is constructed of extruded rubber, but may be constructed of another elastomeric material. Although shown in the FIG. 1 embodiment, the belt edge insert 136 is optional and may be omitted in alternative embodiments (not shown).

The tire 100 further includes a tread cap 142 provided between the tread 102 and the first and second belts 126, 128. The tread cap 142 can be used to assist in holding the components of the tire together (e.g., the belts, plies, and tread). The tread cap 142 can include, for example, one or more polyester or nylon fabric plies. Although shown in the FIG. 1 embodiment, the tread cap 142 is optional and may be omitted in alternative embodiments (not shown).

As shown in FIG. 1, the tire 100 also includes a dual layer reinforcement 144 provided between the carcass ply 114 and the tread 102 and sidewall 104 (or portion thereof) of the tire 100. Although the tire 100 features a dual layer reinforcement 144, the reinforcement can include one layer or three or more layers in alternative embodiments (not shown).

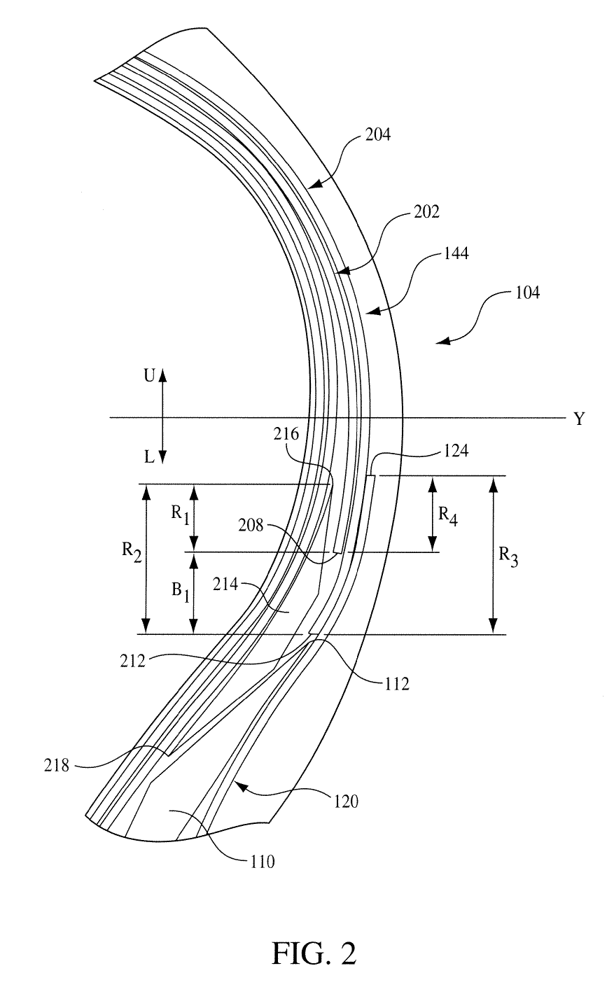

Illustrated in FIG. 2 is an enlarged perspective view of a portion of the tire 100 of FIG. 1 depicting the positioning of the dual layer reinforcement 144 in the tire 100 in greater detail. The dual layer reinforcement 144 includes first and second reinforcement plies 202, 204 that extend circumferentially about the tire 100. The first and second reinforcement plies 202, 204 are provided between the carcass ply 114 and the tread 102 and sidewall 104 of the tire 100. The first reinforcement ply (or inner reinforcement ply) 202 has a lower end 208, while the second reinforcement ply (or outer reinforcement ply) 204 a lower end 212.

As shown in the embodiment illustrated in FIG. 2, the lower end 212 of the second reinforcement ply 204 extends beyond the lower end 208 of the first reinforcement ply 202. More specifically, the lower end 212 of the second reinforcement ply 204 extends downwardly beyond the lower end 208 of the first reinforcement ply 202 a radial distance B₁ between about 3 mm and about 6 mm. In alternative embodiments (not shown), the lower end 212 of the second reinforcement ply 204 may not extend beyond the lower end 208 of the first reinforcement ply 202.

With continued reference to FIG. 2, the tire 100 also includes a bead filler insert 214 having an upper end 216 and a lower end 218. The bead filler insert 214 is positioned above the bead filler 112 and between the reinforcement plies 202, 204 and the carcass ply 114. The bead filler insert 214 is configured to serve as a cushion between the reinforcement plies 202, 214 and the carcass ply 114. The bead filler insert 214 is constructed of rubber, but may be constructed of another elastomeric material. Although the bead filler insert 214 is illustrated as a separate component, it can be an extension of the bead filler 112.

The lower ends 208, 212 of the first and second reinforcement plies 202, 204 terminate in the lower section L of the tire 100. More specifically, the lower ends 208, 212 of the first and second reinforcement plies 202, 204 may extend beyond the upper end 216 of the bead filler insert 214. In other words, the bead filler insert 214 may overlap the first and second reinforcement plies 202, 204. Preferably, the lower end 208 of the first reinforcement ply 202 extends beyond the upper end 216 of the bead filler insert 214 by a radial distance R₁ between about 4 mm and about 6 mm. Similarly, the lower end 212 of the second reinforcement ply 204 extends beyond the upper end 216 of the bead filler insert 214 by a radial distance R₂ between about 10 mm and about 15 mm.

The termination of the lower ends 208, 212 of the first and second reinforcement plies 202, 204 can also be discussed in relation to the turn-up end 124 of the carcass ply 114. For example, the lower ends 208, 212 of the first and second reinforcement plies 202, 204 extend downwardly beyond the turn-up end 124 of the carcass ply 114. In other words, the turn-up portion 118 of the carcass ply 114 overlaps the first and second reinforcement plies 202, 204. Preferably, the lower end 212 of the second reinforcement ply 204 extends beyond the turn-up end 124 of the carcass ply 114 by a radial distance R₃ (which is approximately the same distance as R₂ as shown in FIG. 2) between about 10 mm and about 15 mm. Similarly, the lower end 208 of the first reinforcement ply 202 extends beyond the turn-up end 124 of the carcass ply 114 by a radial distance R₄ (which is approximately the same distance as R₁ as shown in FIG. 2) between about 4 mm and about 6 mm.

Although FIGS. 1 and 2 illustrate only half of a cross-section of the tire 100, the dual layer reinforcement extends to the other sidewall (not shown) of the tire 100 where lower ends of the dual layer reinforcement terminate in the lower section L of the other sidewall (not shown) of the tire 100. In other words, the dual layer reinforcement can be referred to as a “half-ply” reinforcement since it covers the upper half of the tire 100 and extends from the lower section L of one sidewall (e.g., sidewall 104) of the tire to the lower section L of the other sidewall (e.g., the sidewall not shown) of the tire 100.

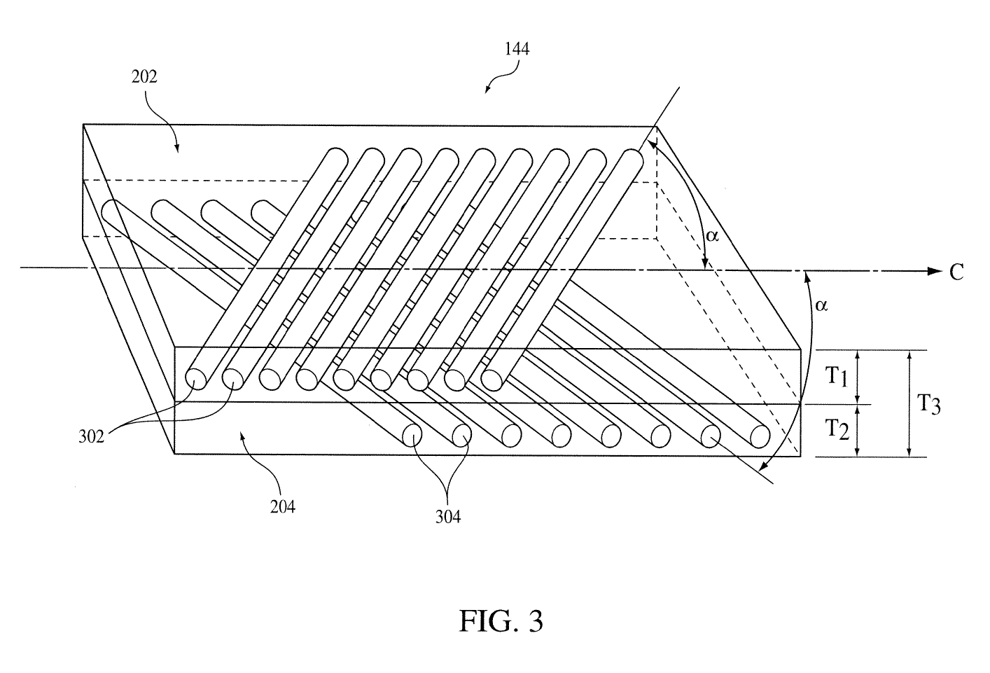

Illustrated in FIG. 3 is a perspective view of a portion of one embodiment of the dual layer reinforcement 144, which includes first and second reinforcement plies 202, 204. The first reinforcement ply 202 includes a first set of parallel-aligned cords 302 encapsulated in rubber or another elastomeric material. Similarly, the second reinforcement ply 204 includes a second set of parallel-aligned cords 304 encapsulated in rubber or another elastomeric material.

As shown in FIG. 3, the dual layer reinforcement 144 is illustrated as an integral component having a first layer (i.e., first reinforcement ply 202) and a second layer (i.e., second reinforcement ply 204). In this case, the dual layer reinforcement 144 can be installed as a single component during the green tire assembly process. In an alternative embodiment (not shown), the first and second reinforcement plies 202, 204 can be discrete layers that are installed separately during the green tire assembly process, yet cooperate with each to form the dual layer reinforcement 144 at the conclusion of the tire manufacturing process.

With reference to FIG. 3, the first and second set of parallel-aligned cords 302, 304 are oriented at an angle α with respect to circumferential direction C of the tire 100. Preferably, the first and second sets of parallel-aligned cords 302, 304 are oriented at an angle α between about 45° and 85° with respect to the circumferential direction C of the tire 100 and are transversely oriented with respect to each other. In alternative embodiments (not shown), the angular orientation of one or both sets of parallel-aligned cords 302, 304 can be less than 45° with respect to the circumferential direction C of the tire 100 depending on the design. In addition, one or both sets of parallel-aligned cords 302, 304 can be radially or circumferentially disposed. Furthermore, the parallel-aligned cords 302, 304 need not be oriented transverse to each other.

The first reinforcement ply 202 preferably has a thickness T₁ between about 0.6 mm and about 1.2 mm and the second reinforcement ply 204 preferably has a thickness T₂ between about 0.6 mm and about 1.2 mm. Most preferably, the first reinforcement ply 202 has a thickness of about 1.0 mm and the second reinforcement ply 204 has a thickness of about 1.0 mm. Hence, the preferred total thickness T₃ of the dual layer reinforcement is about 2.0 mm.

In one embodiment, the first and second sets of parallel-aligned cords 302, 304 are constructed of nylon. In alternative embodiments, one or both sets of parallel-aligned cords 302, 304 may be constructed of polyester, rayon, or steel.

By providing the dual layer reinforcement in one or both sidewalls of a tire, sidewall performance of the tire is improved. For example, when the tire deflects, the dual layer reinforcement is shifted outward towards the sidewall of the tire, thereby increasing the stiffness of the sidewall of the tire. As stiffness of the sidewall of the tire increases, surface strain in the sidewall of the tire decreases. Reduction of surface strain at the sidewall of the tire can lead to a reduction of surface cracks at the sidewall of the tire, a reduction of deflection of the sidewall, and/or an improvement in vehicle handling.

The following example demonstrates the potential effects of providing the dual layer reinforcement in both sidewalls of a tire and should not be construed as limiting the scope or spirit of the present application.

### Example 1

A P255/45R/18 tire, having a maximum allowable inflation of 35 psi and maximum load capacity of 1709 lb (hereinafter referred to as the “Control Tire”), was inflated to 19 psi (its minimum allowable inflation) and mounted on a fixture. A computer system, which employs several cameras focused on the Control Tire, was used to obtain dimensional data of the Control Tire in its unloaded state.

A maximum load of 1709 psi was then applied to the Control Tire causing it to deflect. The computer system then obtained dimensional data of the Control Tire in its loaded state. The dimensional data of the Control Tire in its unloaded state was then compared to the dimensional data of the Control Tire in its loaded state to determine actual strain values along various points on the sidewall of the Control Tire.

This dimensional data was also used to create a computer simulated model of the Control Tire. Modifications could be made to the computer simulated model of the Control Tire to create virtual tires. From these virtual tires, surface strain values along any point on the sidewall of a tire could be predicted. In this case, the computer simulated model of the Control Tire was modified to create a virtual tire that included a half-ply, dual layer reinforcement (nylon cords; 45° equal, but opposite bias) similar to the one described above and shown in FIG. 3 (hereinafter be referred to as the “Reinforced Tire”).

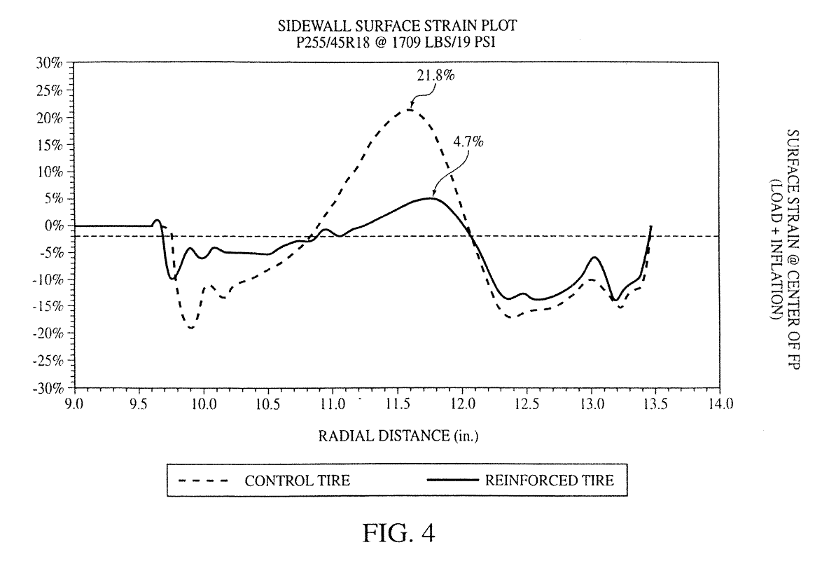

FIG. 4 illustrates the sidewall surface strain graph comparing the predicted surface strain values of the Control Tire with the predicted surface strain values of the Reinforced Tire. The x-axis represents the radial distance in inches from the axis of rotation of the tires, while the y-axis represents the surface strain at the center of the footprint of the tires. In this case, since both tires have a diameter of 18 inches, surface strain measurements were taken at a radial distance beginning at 9 inches and ending at about 13.5 inches (which is the end of the sidewall of the tires). As shown in the graph in FIG. 4, the actual maximum sidewall surface strain of the Control Tire was 21.8%, while the predicted maximum sidewall surface strain of the Reinforced Tire was 4.7%. This represents a reduction in sidewall surface strain of about 17.1%.

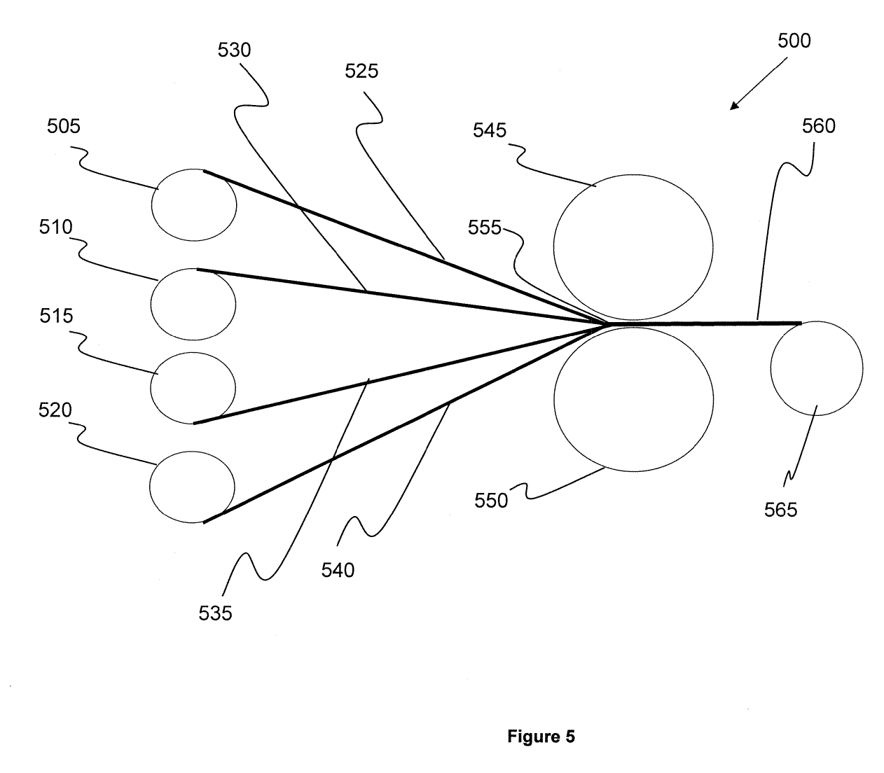

FIG. 5 illustrates a side view of a tire body ply and insert assembly system 500. In the illustrated embodiment, body ply and insert assembly system 500 includes a first rubber coating roller 505, an insert roller 510, a body fabric roller 515, and a second rubber coating roller 520. The rollers can vary in diameter and length to accommodate various material sizes, weights, etc. First rubber coating roller 505 holds a first rubber coating 525, insert roller 510 holds at least one insert 530, body fabric roller 515 holds a body fabric 535, and second rubber coating roller 520 holds a second rubber coating 540. In the illustrated embodiment, first rubber coating roller 505 is above insert roller 510, insert roller 510 is above body fabric roller 515, and body fabric roller 515 is above second rubber coating roller 520. In an alternative embodiment (not shown), body fabric roller 515 may be below first rubber coating roller 505 and above insert roller 510. Second rubber coating 540, body fabric 535, a first insert 530a, and a second insert 530b are below first rubber coating 525.

In the illustrated embodiment, first rubber coating 525, second rubber coating 540, and at least one insert 530 include vulcanized rubber materials. Body fabric 535 comprises woven fabric, e.g., natural and synthetic fabrics. In an alternative embodiment (not shown), first rubber coating 525, second rubber coating 540, and at least one insert 530 are comprised of at least one of the following materials: unvulcanized rubber, polyester calendered with rubber skim on both sides, and the like. In another alternative embodiment (not shown), first rubber coating 525, second rubber coating 540, and at least one insert 530 are constructed of a combination of at least two of the following materials: unvulcanized rubber, polyester calendered with rubber skim on both sides, and the like.

In the illustrated embodiment, rollers deliver first rubber coating 525, at least one insert 530, body fabric 535, and second rubber coating 540 to a calender bite 555 formed by a first calendering roller 545 and a second calendering roller 550. Calender bite 555 presses together (i.e., calenders) first rubber coating 525, at least one insert 530, body fabric 535, and second rubber coating 540 to form a tire body ply and insert assembly 560 that is collected by at least one take up roller 565.

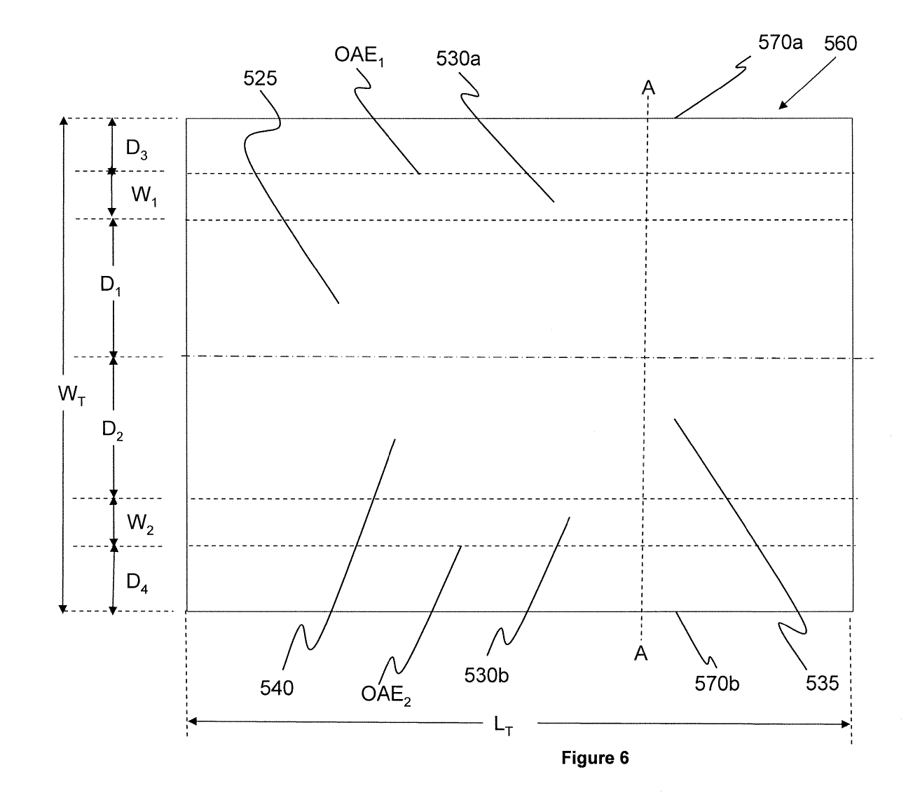

FIG. 6 is a top view of the body ply and insert assembly 560 between the calendering rollers and the at least one take-up roller illustrated in FIG. 5. In the illustrated embodiment, the tire body ply and insert assembly 560 includes a first axial edge 570a, a second axial edge 570b, a total width W_{T}, and a total length L_{T}. For reference, FIG. 6 also shows a centerline C_{L} of the tire body ply assembly 560. First insert 530a has a first width W₁ and is axially spaced from the centerline C_{L} by a first distance D₁. Second insert 530b has a second width W₂ and is axially spaced from centerline C_{L} by a second distance D₂. In the illustrated embodiment, first width W₁ and second width W₂ are about equal and first distance D₁ and second distance D₂ are about equal. Further, an outer axial edge OAE₁ of first insert 530a is axially spaced from first axial edge 570a by a third distance D₃ and an outer axial edge OAE₂ of second insert 530b is axially spaced from second axial edge 570b by a fourth distance D₄. In another embodiment (not shown), first width W₁ and second width W₂ are not equal and first distance D₁ and second distance D₂ are not equal. In yet another embodiment (not shown), outer axial edge OAE₁ of first insert 530a extends to first axial edge 570a (i.e., they share the same axial boundary, D₃=0) and an outer axial edge OAE₂ of second insert 530b extends to second axial edge 570b (i.e., they share the same axial boundary, D₄=0). In another embodiment (not shown), first width W₁ and second width W₂ are variable along the length of the body ply and insert assembly 560. In an example embodiment, first width W₁ and second width W₂ can be from about 25 millimeters to about 50 millimeters and first distance D₁ and fourth distance D₄ can be from about 0 millimeter to about 100 millimeters.

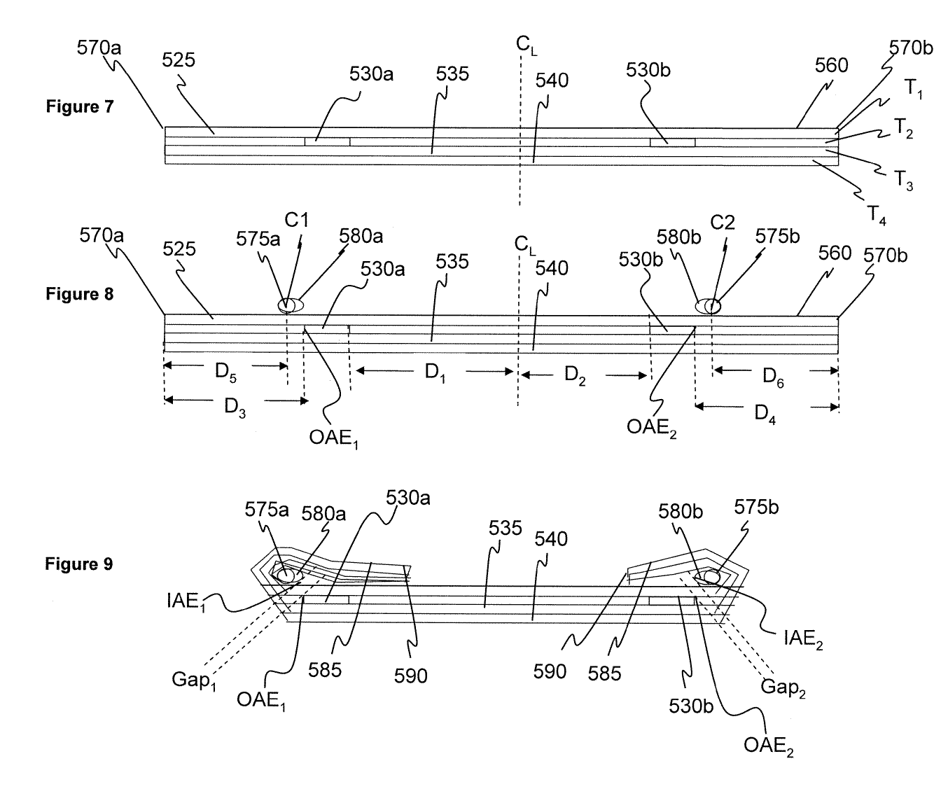

FIG. 7 is a cross sectional view of the body ply and insert assembly 560, along the line A-A of FIG. 6. In the illustrated embodiment, first rubber coating 525 has a first thickness T₁, first insert 530a and second insert 530b each have a second thickness T₂, body fabric 535 has a third thickness T₃, and second rubber coating 540 has a fourth thickness T₄. In an example embodiment, first thickness T₁, second thickness T₂, third thickness T₃, and fourth thickness T₄ each have thicknesses from about 0.2 millimeter to about 0.4 millimeter. In another embodiment (not shown), the body fabric is adjacent first rubber coating 525 and first insert 530a and second insert 530b are adjacent second rubber coating 540.

After body ply assembly 560 has been formed, two bead portions are placed on its top surface. FIG. 8 is a front view of body ply and insert assembly 560 with two bead portions placed on a top surface of assembly 560. Each bead portion includes a bead core 575 having a center C and a bead filler 580. The bead portion left of the center line C_{L} includes bead core 575a having a center C₁ and a bead filler 580a. Center C₁ of first bead core 575a is axially spaced from first axial edge 570a by a fifth distance D₅ and axial outer edge OAE₁ of first insert 530a is axially spaced from first axial edge 570a by third distance D₃, wherein third distance D₃ is greater than fifth distance D₅. In another embodiment (not shown), third distance D₃ is about equal to fifth distance D₅. In yet another embodiment (not shown), third distance D₃ can be from about 1.1 times the fifth distance D₅ to about 3.5 times the fifth distance D₅. In an example embodiment, third distance D₃ is about 20 millimeters to about 50 millimeters greater than fifth distance D₅.

In the illustrated embodiment, the bead portion right of the center line C_{L} includes bead core 575b having a center C₂ and a bead filler 580b. Center C₂ of second bead core 575b is axially spaced from second axial edge 570b by a sixth distance D₆ and axial outer edge OAE₂ of second insert 530b is axially spaced from second axial edge 570a by fourth distance D₄, wherein fourth distance D₄ is greater than sixth distance D₆. In another embodiment (not shown), fourth distance D₄ is about equal to sixth distance D₆. In yet another embodiment (not shown), fourth distance D₄ can be from about 1.1 times the sixth distance D₆ to about 3.5 times the sixth distance D₆. In an example embodiment, fourth distance D₄ is about 20 millimeters to about 50 millimeters greater than sixth distance D₆.

After the bead portions have been placed on the top surface of the body ply assembly 560, the first axial edge 570a and second axial edge 570b are turned up and folded over the respective bead portions. FIG. 9 is a front view of the body ply and insert assembly 560, after the axial edges have been turned up and folded over the bead portions to form two turn-up portions 585, wherein each turn-up portion 585 has a turn-up end 590. Turn-up portions 585 are folded over bead portions so there is an axial gap between the outer axial end (OAE₁, OAE₂) of each insert 530 and inner axial end (IAE₁, IAE₂) of each bead filler 580. Left of the center line C_{L} is a first axial gap GAP₁ and right of the C_{L} is a second axial gap GAP₂. In an example embodiment, first axial gap GAP₁ and second axial gap GAP₂ can be from about 20 millimeters to about 100 millimeters. In another embodiment (not shown), the gap size can vary from what is illustrated in FIG. 9.

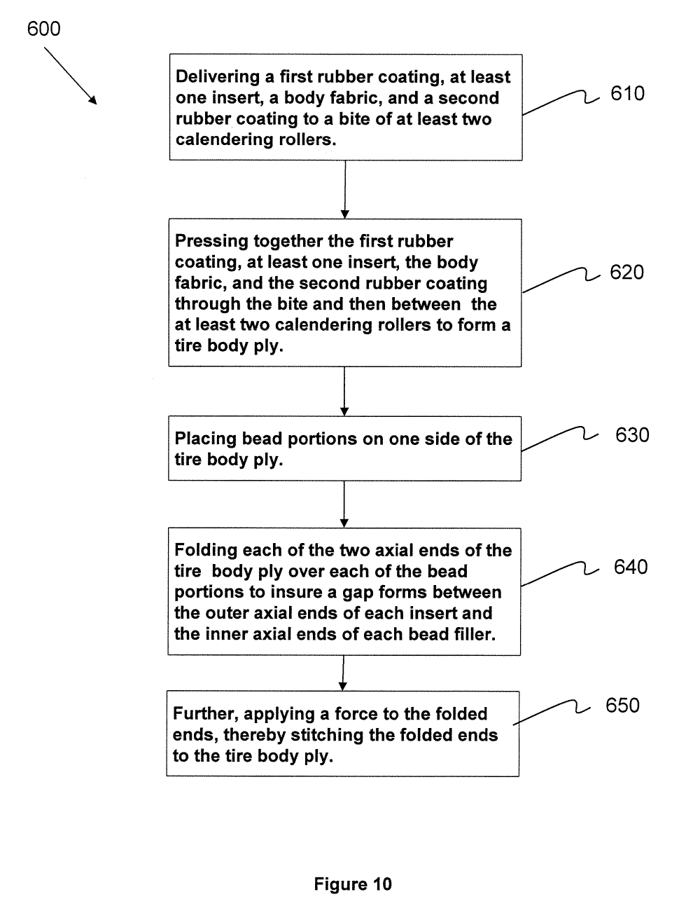

FIG. 10 is a flow diagram illustrating a body ply and insert assembly method 600. As shown in FIG. 10, rolls deliver a first rubber coating, at least one insert, a body fabric, and a second rubber coating to a bite formed by at least two calendering rollers at 610. The rolls press together first rubber coating, at least one insert, body fabric, and second rubber coating as the materials go through the bite and between the at least two rollers at 620. The method the includes placing bead portions on one side of the tire body ply at 630 and further includes folding each axial end of the tire body ply over each of the bead portions to form a gap between the axial end of each insert and the inner axial end of each bead filler at 640. Further, the method includes applying a force to the folded ends so the folded ends are stitched to the tire body ply at 650.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or multiple components.

While the present application illustrates various embodiments, and while these embodiments have been described in some detail, it is not the intention of the applicant to restrict or in any way limit the scope of the claimed invention to such detail. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicant's claimed invention.

What is claimed is:

1. A method for making a tire body ply, the method comprising:
delivering a first rubber coating to a bite formed by at least two calendering rollers;
delivering a first insert to the bite formed by the at least two calendering rollers at a location above the first rubber coating and to the right of a center line of the first rubber coating;
delivering a second insert to the bite formed by the at least two calendering rollers at a location above the first rubber coating and to the left of the center line of the first rubber coating
delivering a body fabric to the bite formed by the at least two calendering rollers at a location above the first insert and the second insert;
delivering a second rubber coating to the bite formed by the at least two calendering rollers at a location above the body fabric; and
pressing the first rubber coating, the body fabric, the first insert, the second insert, and the second rubber coating through the bite and between the at least two calendering rollers.

2. The method of claim 1, wherein the first insert has a first width and the second insert has a second width about equal to the first width.

3. The method of claim 1, wherein the first insert has a first width and the second insert has a second width greater than the first width.

4. The method of claim 1, further comprising placing the first insert at a location axially spaced from a centerline of the tire body ply by a first distance.

5. The method of claim 4, further comprising placing the second insert at a location axially spaced from a centerline of the tire body ply by a second distance.

6. The method of claim 5, further comprising positioning the first insert at a location spaced from a first axial edge of the tire body ply by a third distance and positioning the second insert at a location spaced from a second axial edge of the tire body ply by a fourth distance.

7. The method of claim 6, wherein the third distance and the fourth distance are about equal.

8. The method of claim 6, further comprising placing two bead portions on a side of the tire body ply, wherein each bead portion includes a bead core having a center and a bead filler, wherein a first center of a first bead core is spaced from the first axial edge of the tire body ply by a fifth distance and a second center of a second bead core is spaced from the second axial edge of the tire body ply by a sixth distance.

9. The method of claim 8, wherein the fifth distance and the sixth distance are about equal.

10. The method of claim 8, further comprising placing the first bead portion in a first position on the tire body ply so there is a first gap between an inner axial edge of a first bead filler and an outer axial edge of the first insert, and placing the second bead portion in a second position on the tire body ply so there is a second gap between an inner axial edge of a second bead filler and an outer axial edge of the second insert.

11. A method for preforming a tire body ply and a bead portion, the method comprising:
pressing a first rubber coating, a body fabric, at least one insert, and a second rubber coating through a bite and between at least two calendering rollers to form a tire body ply;
placing bead portions on one side of the tire body ply, wherein the bead portions comprise a bead core having a center and a bead filler, wherein a first center of a first bead core is spaced from a first axial edge of the tire body ply by a first distance and a second center of a second bead core is spaced from a second axial edge of the tire body ply by a second distance;
folding a first axial end of the tire body ply over a first bead portion to form a first folded end, wherein the first folded end encloses the first bead portion; and
folding a second axial end of the tire body ply over a second bead portion to form a second folded end, wherein the second folded end encloses the second bead portion.

12. The method of claim 11, further comprising applying a force to the folded ends, thereby stitching the folded ends to the tire body ply.

13. The method of claim 11, wherein the first rubber coating and the second rubber coating each have a thickness from about 0.005 inch to about 0.02 inch.

14. The method of claim 11, wherein the at least one insert has a thickness from about 0.01 inch to about 0.20 inch.

15. The method of claim 11, further comprising positioning a first insert having a first width and spacing it from a center of the tire body ply by a third distance and positioning a second insert having a second width and spacing it from the center of the tire body ply by a fourth distance.

16. The method of claim 11, further comprising forming a gap between the bead filler and the at least one insert, wherein the bead filler and the at least one insert overlap and the gap forms along an entire interface of the bead filler and the at least one insert, and wherein the gap along the entire interface of the bead filler and the at least one insert consists of a rubber material.

17. The method of claim 11, further comprising forming a gap between the bead filler and the at least one insert, wherein the bead filler and the at least one insert overlap and the gap forms along an entire interface of the bead filler and the at least one insert, and wherein the gap along the entire interface of the bead filler and the at least one insert does not include carcass cords.

18. A method for making a tire body ply, the method comprising:
delivering a first rubber coating to a bite formed by at least two calendering rollers;
delivering at least one insert to the bite formed by the at least two calendering rollers;
delivering a body fabric to the bite formed by the at least two calendering rollers;
delivering a second rubber coating to the bite formed by the at least two calendering rollers;
pressing the first rubber coating, the body fabric, the at least one insert, and the second rubber coating through the bite and then between the at least two calendering rollers to form a tire body ply having a total width, a thickness, and a length,
wherein the body fabric and the at least one insert are between the first rubber coating and the second rubber coating and the at least one insert is between the first rubber coating and the body fabric, and
wherein a first insert having a first width is spaced from a center of the tire body ply by a second width and a second insert having a third width is spaced from the center of the tire body ply by a fourth width
placing bead portions on one side of the tire body ply, wherein the bead portions comprise a bead core having a center and a bead filler and wherein each bead core center is at a first axial distance that is less than a second axial distance of an axial edge of the at least one insert, wherein the first axial distance of each bead core and the second axial distance of the axial edge of the at least one insert are measured from two distinct axial ends of the tire body ply;
folding each of the two axial ends of the tire body ply over each of the bead portions to form a pair of folded ends, wherein the bead portions are enclosed by one of the two axial ends of the tire body ply; and
applying a force to the pair of folded ends, thereby stitching the pair of folded ends to the tire body ply.

19. The method of claim 18, further comprising forming a gap between the bead filler and the at least one insert, wherein the bead filler and the at least one insert overlap and the gap forms along an entire interface of the bead filler and the at least one insert, and wherein the gap along the entire interface of the bead filler and the at least one insert consists of a rubber material.

20. The method of claim 18, further comprising forming a gap between the bead filler and the at least one insert, wherein the bead filler and the at least one insert overlap and the gap forms along an entire interface of the bead filler and the at least one insert, and wherein the gap along the entire interface of the bead filler and the at least one insert does not include carcass cords.
